(19) United States
(12) Patent Application Publication
(10) Pub. No.: US 2017/0068816 A1
(43) Pub. Date: Mar. 9, 2017

(54) MALWARE ANALYSIS AND DETECTION USING GRAPH-BASED CHARACTERIZATION AND MACHINE LEARNING

(71) Applicant: JOHN CAVAZOS, Newark, DE (US)

(72) Inventor: JOHN CAVAZOS, Newark, DE (US)

(73) Assignee: UNIVERSITY OF DELAWARE, Newark, DE (US)

(21) Appl. No.: 15/256,883

(22) Filed: Sep. 6, 2016

Related U.S. Application Data
(60) Provisional application No. 62/214,270, filed on Sep. 4, 2015.

(51) Int. Cl. G06F 21/56; G06N 3/04; G06N 3/08

(52) U.S. Cl. CPC G06F 21/566; G06N 3/08; G06N 3/04; G06F 2221/034

(57) ABSTRACT

Malware detection methods systems, and apparatus are described. Malware may be detected by obtaining a plurality of malware binary executables and a plurality of goodware binary executables, decompiling the plurality of malware binary executables and the plurality of goodware binary executable to extract corresponding assembly code for each of the plurality of malware binary executables and the plurality of goodware binary executable, constructing call graphs for each of the plurality of malware binary executables and the plurality of goodware binary executables from the corresponding assembly code, determining similarities between the call graphs using graph kernels applied to the call graphs for each of the plurality of malware binary executables and the plurality of goodware binary executables, building a malware detection model from the determined similarities between call graphs by applying a machine learning algorithm such as a deep neural network (DNN) algorithm to the determined similarities, and identifying whether a subject executable is malware by applying the built malware detection model to the subject executable.

### CROSS REFERENCE TO RELATED APPLICATIONS

The present application claims priority to U.S. Provisional Application Ser. No. 62/214,270 to John Cavazos titled Malware Analysis and Detection Using Graph-Based Machine Learning filed on Sep. 4, 2015, which is incorporated fully herein by reference.

### BACKGROUND OF THE INVENTION

Malicious software, i.e., malware, has become increasingly numerous. Some analysts estimate there are tens of thousands of new malware being released into the wild every hour. It appears as if the industry is in agreement that data breaches cannot be stopped —saying it is not a matter of “if” a company will be breached, but “when” it will be breached. One major reason for the seemingly unstoppable data breaches is that bad actors have embraced automation to construct malware. In contrast, most security companies that develop products to detect malware still construct them manually. This antiquated method of constructing malware detection systems cannot keep up with the massive amounts of new malware variants created every day.

Adaptive, learning-based techniques are being considered for constructing malware detection engines, instead of the traditional manual-based strategies. Prior work in learning-based malware detection engines primarily focuses on dynamic trace analysis and byte-level n-grams. There is an ever present and increasing need for improved systems and methods for detecting and analyzing malware.

### SUMMARY OF THE INVENTION

The present invention is embodied in methods, systems, and apparatus for detecting malware. Malware may be detected by obtaining a plurality of malware binary executables and a plurality of goodware binary executables, decompiling the plurality of malware binary executables and the plurality of goodware binary executable to extract corresponding assembly code for each of the plurality of malware binary executables and the plurality of goodware binary executable, constructing call graphs for each of the plurality of malware binary executables and the plurality of goodware binary executables from their corresponding assembly code, determining similarities between the call graphs using graph kernels applied to the call graphs for each of the plurality of malware binary executables and the plurality of goodware binary executables, building a malware detection model from the determined similarities between call graphs by applying a machine learning algorithm such as a deep neural network (DNN) algorithm to the determined similarities, and identifying whether a subject executable is malware by applying the built malware detection model to the subject executable.

### BRIEF DESCRIPTION OF THE DRAWINGS

The invention is best understood from the following detailed description when read in connection with the accompanying drawings, with like elements having the same reference numerals. When a plurality of similar elements is present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Also, lines without arrows connecting components may represent a bi-directional exchange between these components. Included in the drawings are the following figures:

FIG. 1 is a block diagram depicting an exemplary detection system for performing aspects of the invention;

FIG. 2A is a schematic representation of a training system for developing a malware detection model in accordance with aspects of the invention;

FIG. 2B is a schematic representation of a testing and malware identification system in accordance with aspects of the invention;

FIG. 3 is a flow chart of steps for detecting malware in accordance with aspects of the invention;

FIG. 4 is a flow chart of steps for identifying malware in FIG. 3 in accordance with aspects of the invention;

FIG. 5 is a workflow diagram of a binary representation to a call graph-based representation with extracted features in accordance with aspects of the invention;

FIG. 6A is a graph depicting edge connections representing possible flow of execution for an application;

FIG. 6B is a shortest, path graph depicting the length of shortest paths between each edge in the graph of FIG. 6A;

FIG. 7A is pseudocode for a shortest path graph kernel in accordance with aspects of the invention; and

FIG. 7B is pseudocode for a fast shortest path graph kernel in accordance with aspects of the invention.

### DETAILED DESCRIPTION OF THE INVENTION

A self-tuning and scalable malware analysis and detection method and system are described that adapt detection rules automatically to match the characteristics of the latest targeted attacks—thereby dramatically shortening the cycle from malware discovery to malware rules construction and deployment. In accordance with one aspect of the invention, graph-based compiler representations of binaries are used and the graphs are analyzed with machine learning algorithms (i.e., graph kernels) that take graphs as their input. These algorithms are effective at learning the subtle differences between goodware (non-malicious applications) and malware; however, they are computationally expensive. The algorithms may be optimized and run on an accelerator, e.g., a GPU, to reduce computational expense. As used herein the term/phrase GPU refers to conventional GPUs and other special purpose accelerators, e.g., Intel Xeon Phi's or FPGAs.

As an overview, graph-based representations (“call graphs”) of binaries are utilized. A call graph represents the caller-callee relationship between functions. From the assembly code, other types of compiler representation graphs of the binary can be constructed, e.g., a control flow graph (CFG), which represents the control flow (branches) between blocks and/or a data flow graph (DFG), which represents the data flow (read/write dependencies) between instructions. For each of these graphs, the nodes may be labeled with feature vectors representative of the information in the node. Various statistics may be aggregated for each instruction, block, and/or function in the binary. In addition, blocks and/or functions may be characterized by their instruction histogram and/or an instruction 2-gram. Using graph-based representations provides structure, which can be used to learn more advanced patterns.

In an embodiment, a kernel function, e.g., Shortest Path Graph Kernel (SPGK), is used to identify similarities between call graphs extracted from executables and to create a similarity matrix. The similarity matrix is then fed into a machine learning algorithm, such as a deep neural network (DNN) machine learning algorithm to construct models that can be used to predict whether a binary is malicious (i.e., malware) or not.

A suitable DNN transforms inputs using a succession of neuron layers to produce an output. A stochastic gradient descend (SGD) may be used to train the (DNN). SGD can, be used alongside back-propagation to correct the DNN's parameters to reduce the DNN's error. One open source DNN framework that can be used is Theano, which is a Python library that provides highly optimized GPU implementations. Using this library, it is possible to build DNNs with a large number of layers. Each layer contains a large number of neurons, weights, biases, and different activation functions associated with each neuron. Instantiations of a DNN could have linear, softmax logistic sigmoid, and hyperbolic tangent as action functions in the neurons. In addition to searching, for the right activation functions that give the best performance, one can use L1 and L2 regularization functions to improve a DNN's generalization ability. These regularization functions add penalties to DNN's where layers have a large L1 and L2 norms. L1 and L2 regularizations penalize large weights, which encourage non-linear behaviors of the network. The DNNs described herein can be used to build classifiers, e.g., to be used to classify malware versus goodware or to determine what family a particular malware comes from or what kind of capabilities the malware may contain. For classifier DNNs, the action function of the output layer may be a softmax function and the loss function may be a negative log-likelihood.

SPGK algorithms are computationally expensive due to the size of the input graphs. Therefore, parallelization methods using central processing units (CPUs) and/or graphic processing units (GPUs) may be used to speed up this kernel. The data may be partitioned based on graph size to run on the most appropriate architecture. Accuracy using the approach described herein reaches 99.5% accuracy on binary classification (malware versus goodware) and gives a false positive rate (FPR) of less than 0.1%. Switching from a binary classifier to a multi-class prediction model (e.g., predicting what family a malware belongs to or what kind of capabilities the malware may contain) has a small effect on classification accuracy. Also, large call graphs and dataset sizes can be considered because of the reduced execution time of the inventor's parallelized SPGK implementation. Using optimized and parallelized SPGK and DNN implementations can scale to learning from extremely large data sets of malware.

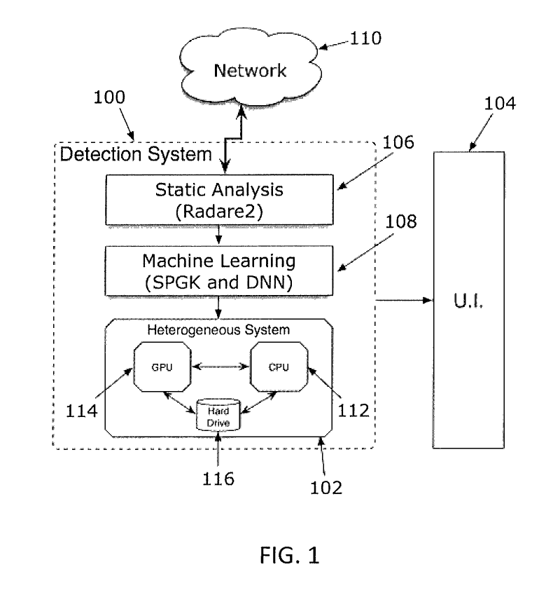

FIG. 1 depicts a detection system 100 that may be used to detect malware in accordance with aspects of the invention. The illustrated detection system includes a heterogeneous system 102, a user interface 104, static analysis component(s) 106, and machine learning component(s) 108. The components for detection system 100 may be interconnected via a bus. Detection system 100 may communicate with a network 110 to receive executables for developing a malware model and/or to receive subject executables for analysis and these models and analyses may be stored on hard drive 116. The network 110 may be an intranet or an extranet (e.g., the Internet).

Heterogeneous system 102 is configured to carry out steps described herein. In an embodiment, system 102 is configured to analyze files with static analysis component 106 using a disassembler (e.g., Radare2; described below). CPU 112 may execute Radare2 and store the output on hard drive 116. Machine learning components 108, e.g., graph kernels and a DNN, may also be executed on the heterogeneous system. Illustrated heterogeneous system 102 includes a CPU 112 and a GPU 114. CPU 112 may be a multi-core processor. A suitable CPU 112 is an Intel i7-5860 K (6 @ 3.5 GHz) including 32 GB DDR4 2133 MHz of random access memory. A suitable GPU 114 is an NVIDIA GTX 970 including 4 GB GDDR5 (3.5 GB+0.5 GB) of virtual RAM (VRAM). As used herein, the term hard drive encompasses a hard disk drive(s) and/or a solid state drive(s). A suitable hard drive 116 is a Seagate Desktop 2 TB Internal HDD—3.5″—ST2000DM001—SATA 6 Gb/s—7,200 rpm. The heterogeneous system can be 1) one CPU 112 and one GPU 114 (as depicted), 2) one CPU 112 and no GPU, 3) multiple CPUs and GPUs.

User interface 104 included user inputs such as a mouse and keypad and user outputs such as a video monitor. CPU 112 and GPU 114 are configured to store a similarity matrix (e.g., developed during training), similarity vectors (e.g., developed during testing), and feature vectors and graph-based representations from malware analysis performed by heterogeneous system 102. Additionally, CPU 112 or GPU 114 can be configured to store DNN predication models learned by system 102 and actual and predicted labels for training and test sets.

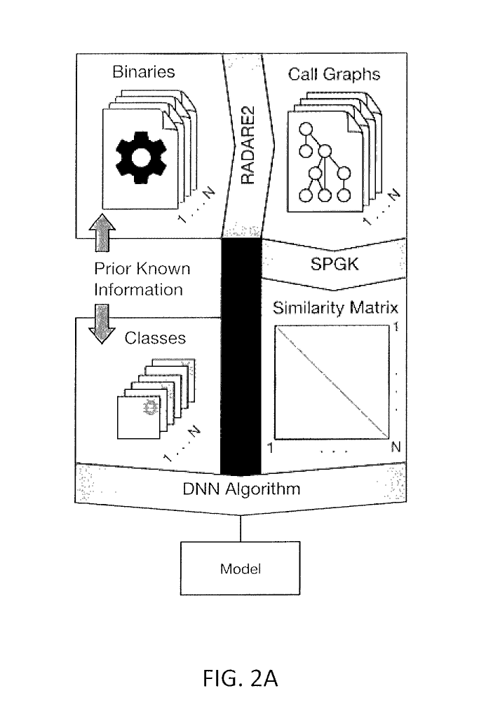

FIG. 2A depicts a workflow for construction o f a machine learning model during a training, phase and FIG. 2B depicts a workflow for testing and detection of malware in accordance with aspects of the invention.

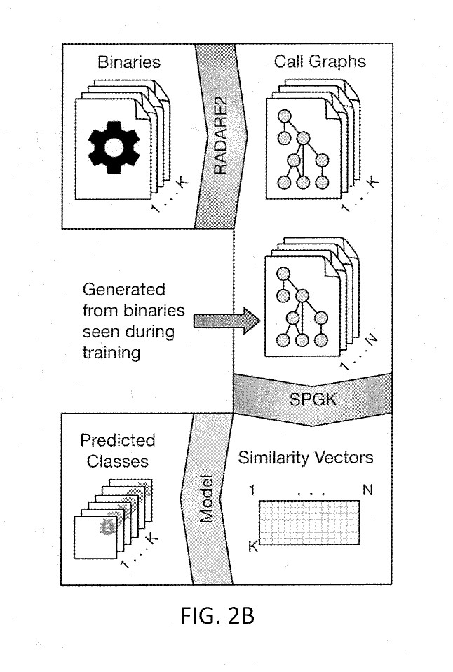

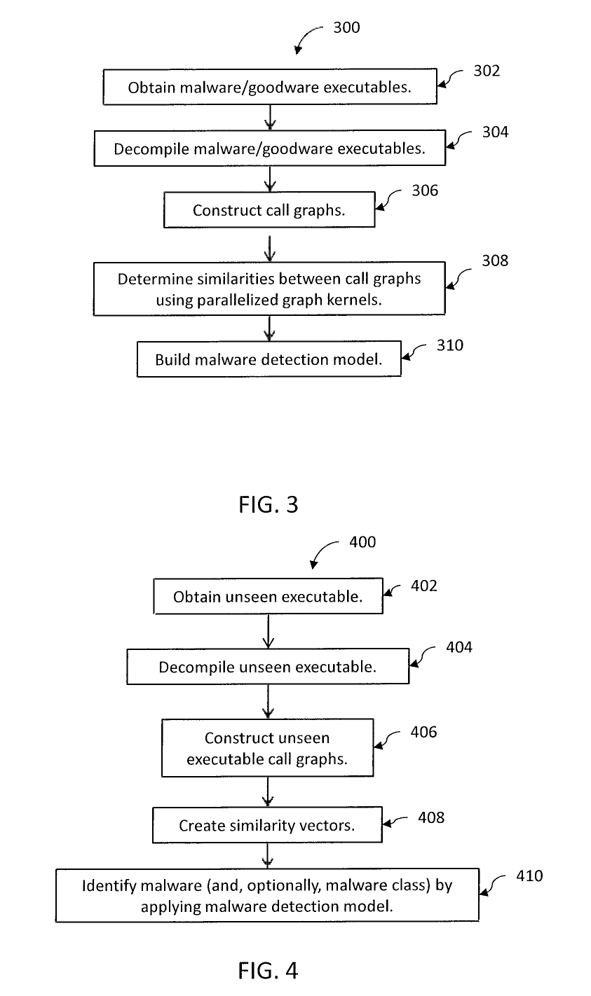

FIG. 3 depicts a method 300 for detecting malware in accordance with as of the invention and FIG. 4 depicts a method 400 for identifying malware in the method of FIG. 3. The steps of method 300 and method 400 are described below with reference to detection system 100 and the workflows depicted in FIGS. 2A and 2B. It will be understood by one of skill in the art that the method 300 may be performed using alternative systems and workflows. For example, the steps may be computed on essentially any processing element(s) (e.g., a CPU, a CPU and a GPU, etc.). Additionally, it will be understood that one or more of the steps of method 300 may be omitted and steps may be performed in order.

At step 302, executable code (e.g., an application in binary form) for analysis is obtained. Executable code may be obtained by detection system 100 from network 110 and analyzed using static analysis component 106.

At step 304, the executable code is decompiled to obtain assembly code. The assembly code may be extracted using a disassembler running on detection system 100. A suitable disassembler is Radare2 (available for download from http://radare.org/r/down.html). Radare2 extracts the assembly code and, as described below, may be used to produce a call graph for each of the application's functions. Disassembly allows examination of structural qualities of an application, i.e., the caller/callee relationship of the application's functions, as well as the types of instructions used each function. In an embodiment, CPU 112 decompiles malware and goodware binary executables to obtain the assembly code.

Given an executable file, Radare2 produces a list of routines, where each routine is a list of blocks and each block contains a list of instruction. In addition to the offset, opcode, and operands, radare2 associates to each instruction one of 53 categories (control flow instructions (jmp, ujmp cjmp, ucjmp, switch, case, call, ucall, ccall, uccall, ret, and cret), arithmetic instructions (mov, cmov, swi, length, cmp, acmp, add, sub, abs, mul, div, shr, shl, cpl, sal, sar, or, and xor, crypto, nor, not, lea, xchg, ror, rol, mod, cast), memory instructions (store, load, upush, push, pop, new, leave, and io), and miscellaneous instructions (null, nop, unk, trap, and ill)).

At step 306, call graphs are constructed for each application. The call graphs may be constructed for each application by detection system 100. Each function is represented by a feature vector corresponding to a histogram of all the instructions in the function. These feature vectors enable representation of the total number of instructions in a given function call. Combining the feature vectors and call graphs provided a very expressive representation of an application, as well as its content. In an embodiment, CPU 112 constructs the call graphs and stores the constructed call graphs to hard drive 116.

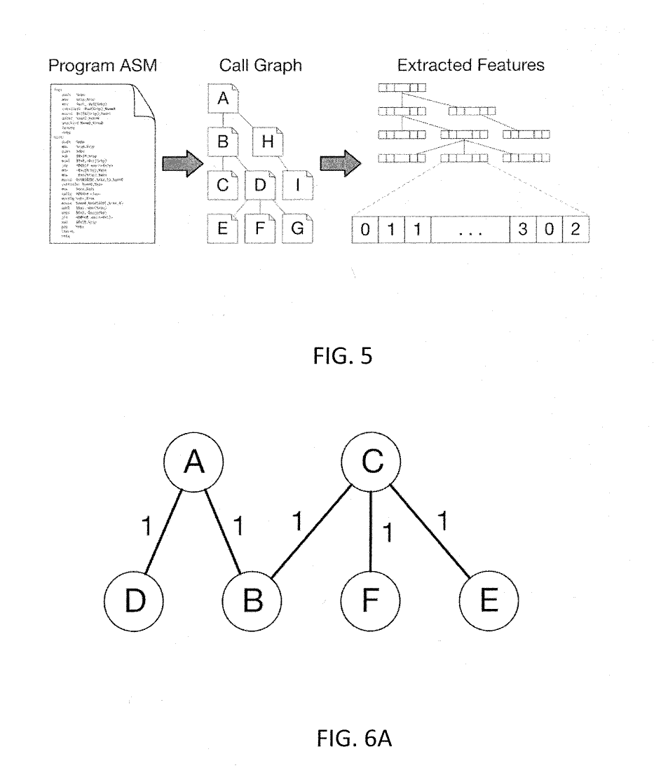

Formally, a call graph (CG) can be represented as G=[V, E], where V is a set of nodes and each node v ∈ V represents one of the functions. E ∈ V×V denotes the directed edges, where an edge e_{i,j}=(vᵢ, vⱼ) represents a call from the caller function represented by vᵢ to the callee function represented by vⱼ. Each vertex may be labeled with a feature vector representing a histogram of the instructions in the function. FIG. 5 shows the transformation flow from binary representation (assembly) to a graph-based representation with extracted feature vectors for each function.

In the call graph, the nodes represent the binary's functions, while the directed edges represent the caller-callee relationship between functions. For each function in the assembly, the number of occurrences of each category of instruction is counted to form a histogram of 53 elements for each function. This histogram may then be used to label the corresponding node.

At step 308, similarities between the call graphs are determined used a graph kernel. A parallel implementation of the Shortest Path Graph Kernel (SPGK) may be used that makes use of both the CPU 112 and GPU 114 to efficiently perform these comparisons, which is described in further detail below. Alternatively, either CPU 112 or GPU 114 may determine call graph similarities. The output of the SPGK is a similarity matrix that can be used as input to a machine learning algorithm such as a DNN machine learning algorithm.

The SPGK algorithm takes as input a collection of graphs and determines how similar they are to each other. The output of this algorithm is a kernel matrix, which corresponds to the pairwise similarity values of each pair of graphs in the dataset. In order to run SPGK on a graph, we first use a Floyd-Warshall algorithm to convert the graph into a fully connected, all-pairs shortest path graph. Given a graph G=[V, E], which is comprised of a set of V vertices and E edges, a shortest path graph is a graph S=[V, E], where V′=V and E′={e′₁, . . . , e′ₘ} such that e′i =(uᵢ, vᵢ) if the corresponding vertices uᵢ and vᵢ are connected by a path in G. The edges in the shortest path graph are labeled with the shortest distance between the two nodes in the original graph. Since the computation of the similarity of each pair of graphs are not data dependent, parallelism can be used to accelerate this algorithm.

The Shortest Path Graph Kernel (SPGK) counts the number of shortest paths of the same length having similar start and end vertex labels in two input graphs. One of the motivations for using this kernel is that it avoids the problem of “tottering” found in other graph kernels. Tottering is the act of visiting the same nodes multiple times thereby artificially creating high similarities between the input graphs. In shortest path kernels, vertices are not repeated in paths, so tottering is avoided.

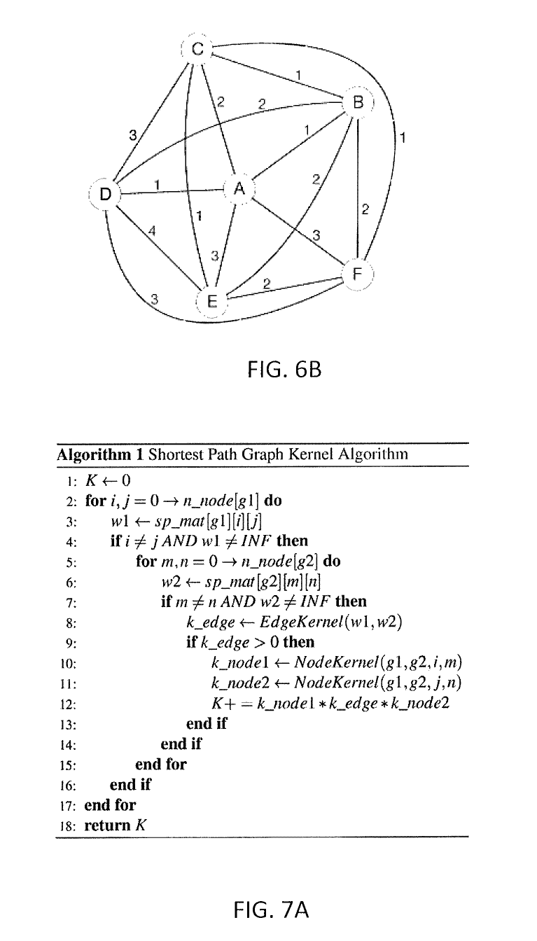

A graph kernel based on shortest paths determines all shortest distances in a graph, a problem that is solvable in polynomial time. In order to define a kernel that counts shortest paths of similar distances, the original graphs are transformed into shortest path graphs. FIGS. 6A and 6B illustrates the transformation of a labeled graph (FIG. 6A) into a shortest path graph (FIG. 6B. FIGS. 6A and 6B depicts a labeled graph and its associated shortest path graph, with both graphs having the same set of vertices. Every edge connecting a pair of vertices in the shortest path graph (FIG. 6B) is labeled with the length of the shortest path between these pair of vertices in the original graph (FIG. 6A).

Once the shortest path graph is computed for each graph, the shortest path graphs are used to compute similarity between two graphs using the Short Path Graph Kernel (SPGK) algorithm. SPGK for two shortest path graphs S₁=[V₁, E₁] and S₂=[V₂, E₂] is computed as follows:

K_{SPGK}(S₁, S₂)=Σₑ₁_{^{∈}}_{E1}Σₑ₂_{^{∈}}_{E2}kwalk (e₁, e₂) (1)

where k_{walk} is a kernel for comparing two edge walks. The edge walk kernel k_{walk} is the product of kernels on the vertices and edges along the walk. It can be calculated based on the start vertex, the end vertex, and the edge connecting both. Let e₁ be the edge connecting nodes u₁ and v₁ of graph S₁, and e₂ be the edge connecting nodes u₂ and v₂ of graph S₂. The edge walk kernel is defined as follows:

k_{walk}(e₁, e₂)=k_{node}(u₁, u₂)*K_{edge}(e₁, e₂)*K_{node}(v₁, v₂) (2)

where k_{node} and k_{edge} are kernel functions for comparing vertices and edges, respectively.

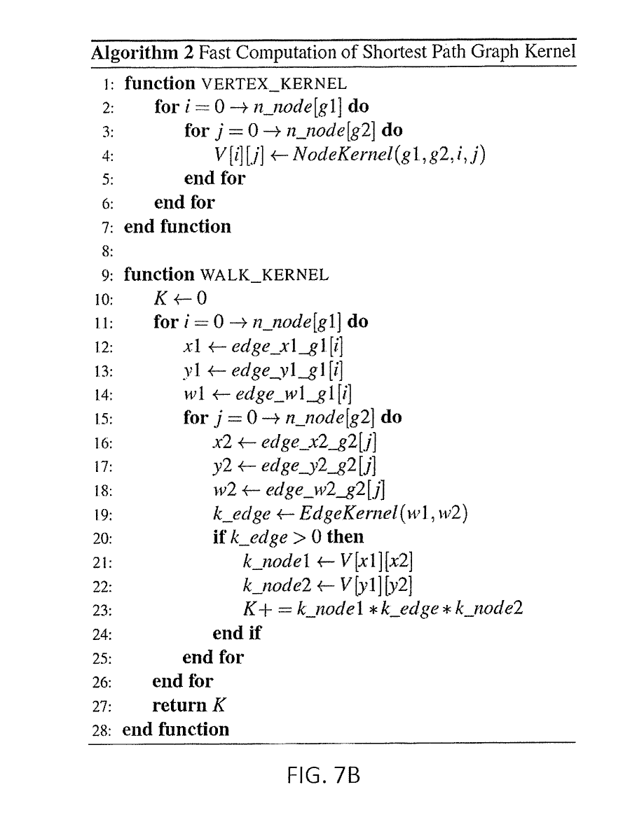

Pseudocode or for a naive implementation of the Shortest Path Graph Kernel is presented in Algorithm 1, which >is depicted in FIG. 7A. Given two input graphs g1 and g2, lines 2-7 loop over the shortest path matrices to find all pairs of paths. Line 8 calculates the k_{edge} and lines 10-11 calculate k_{node}. Line 12 calculates k_{walk} and computes the summation.

This kernel is attractive because it retains expressivity while avoiding tottering, i.e., multiple visits to the same node in the graph. Moreover, it allows for continuous labels in vertices and edges.

An implementation of the shortest path graph kernel (Algorithm 1; FIG. 7A) has three potential issues that slow down its performance. First, four for loops and two if statements, slow down the algorithm's performance. Second, there is potential redundant computation performed by knode. Third, there is a drawback in the random memory access pattern in Algorithm 1.

To address the issues of Algorithm 1, a fast computation of shortest path graph kernel (FCSP) may be used. In this method, the calculation of the shortest path, graph kernel is divided into two main components: 1) calculating all possible instances of k_{node} into a vertex kernel matrix and 2) calculating all required values for k_{walk}. The pseudo-code for an exemplary FCSP is presented in Algorithm 2, which is depicted in FIG. 7B. Given input graphs g1 and g2, function Vertex_Kernel calculates all possible instances of k_{node} sequentially and stores them in a matrix V for later access. Function Walk_Kernel takes advantage of the three 1D arrays converted from shortest path matrix, which creates more sequential memory access and less branch divergence. Branch divergence is important to reduce for GPUs because parallel threads that execute “divergent” paths in the code can slow down performance. The Walk_Kernel calculates all k_{walk} computation and sums them up as the final similarity between two input graphs.

A CPU implementation (CPU 112) of this algorithm can be parallelized to perform independent computation of the FCSP on separate independent processors on a multi-core processor. A GPU implementation (GPU 114) will involve massively parallelizing computation using a naïve implementation that involves computing the Vertex and Walk Kernel functions of FCSP for independent pair-wise graph comparison. A more complex and more efficient CPU/GPU implementation would parallelize the pair-wise similarity of large graphs on a GPU and perform small graph comparisons concurrently on the CPU.

At step 310, a malware detection model/classifier is built. The malware detection model/classifier may be built using a machine learning algorithm such as the DNN and stored to hard drive 116. The DNN includes two phases: training (FIG. 2A) and testing/detecting (FIG. 2B). Given labeled samples in the training phase, as depicted in FIG. 2A, a DNN finds a hyperplane that separates classes of malware and goodware. During the testing phase, samples are classified by the DNN, prediction model and assigned a label. In an embodiment, a parallel implementation may be used that applies a machine learning algorithm running on both the CPU 112 and GPU 114. Alternatively, either CPU 112 or GPU 114 may run the machine learning algorithm.

In the training phase, the similarity matrix from the SPGK algorithm can be fed into the DNN prediction model along with correct labels from the training data. In the testing phase, shown in FIG. 2B, the samples are classified using the prediction model. To use a kernel matrix as input, the decision function can be transformed to Equation 3. In this equation, yᵢ is the class label of training data, w* and αᵢ are parameters of the prediction model computed from the training data. K(Rᵢ, R) is the kernel value between a testing representation R and a training representation Rᵢ. Once the kernel values are filled with the kernel matrix, the testing data is classified.

f(R)=(w*+Σ^{N}ᵢ₌₀αᵢyᵢK(Rᵢ, R)) (3)

In the method 400 of FIG. 4, malware is identified (and optionally classified). The malware detection model built in step 310 is applied to a subject application to identify whether the subject application is malicious, and if it is malicious, the malware detection model may further be used to classify the family of malicious software it is a variant of or what kind of capabilities the malware may contain.

At block 402, a subject executable is obtained. The subject executable may be obtained in a manner similar to the executables obtained in step 302 described above.

At block 404, the subject executable is decompiled. The subject executable may be decompiled in a manner similar to the executable decompiled in step 304 described above.

At block 406, call graphs are constructed for the subject executable. The call graphs are constructed in a manner similar to the methods described above.

At block 408, similarity vectors are generated. The similarity vectors may be generated using a graph kernel (such as a parallelized graph kernel) that represents the similarity between the subject call graphs and the call graphs for each of the plurality of malware binary executables and the plurality of goodware binary executables.

During training, the similarity matrix contains the similarities of all pair-wise graph comparisons. The graphs used to construct the similarity matrix are also labeled with their correct classification and therefore the similarity matrix and labels can be used to train a machine learning algorithm. For testing, an “unseen” graph is used, i.e., one that was not used during training, to construct a similarity vector with all the labeled “seen” graphs from our training set. This similarity vector can be fed to a DNN to extract the predicted label for the “unseen” graph.

At block 410, a subject application is identified as malicious or as not malicious. In an embodiment, the malware detection model built in step 310 can be used to identify if the subject application is malicious by feeding it input from the analysis of an “unseen” subject application. A similarity vector is computed for this “unseen” subject application and the malware detection model identifies whether it is malicious; and, if it is malicious, it may further be used to classify the family of malicious software it is a variant of or what kind of capabilities the malware may contain.

Although the invention is illustrated and described herein with reference to specific embodiments, the invention is not intended to be limited to the details shown. Rather, various modifications may be made in the details within the scope and range of equivalents of the claims and without departing from the invention. For example, although the detailed specification describes decompiling binaries to get assembly level call graphs made up of lower level assembly instructions, call graphs could be derived by compiling source code—which would yield call graph made up of higher level statements.

What is claimed:

1. A malware detection method, the, method comprising:
obtaining a plurality of malware binary executables and a plurality of goodware binary executables;
decompiling the plurality of malware binary executables and the plurality of goodware binary executable to extract corresponding assembly code for each of the plurality of malware binary executables and the plurality of goodware binary executable;
constructing call graphs for each of the plurality of malware binary executables and the plurality of goodware binary executables from the corresponding assembly code;
determining similarities between the call graphs using graph kernels applied to the call graphs for each of plurality of malware binary executables and the plurality of goodware binary executables;
building a malware detection model from the determined similarities between call graphs by applying a machine learning algorithm to the determined similarities;
identifying whether a subject executable is malware by applying the built malware detection model to the subject executable.

2. The method of claim 1, further comprising:
associating one of a plurality of malware classes with each of the plurality of malware binary executables, wherein the building step incorporates the associated classes in the built malware detection model using the machine learning algorithm; and
classifying the subject executable into one of the plurality of malware classes using the built malware detection model.

3. The method of claim 1, wherein the identifying step comprises the steps of:
obtaining the subject executable;
decompiling the subject executable to extract subject assembly code;
constructing subject call graphs representing the subject assembly code;
creating similarity vectors representing similarity between the subject call graphs and the call graphs for each of the plurality of malware binary executables and the plurality of goodware binary executables using the graph kernels; and
identifying the subject executable as potential malware by applying the built malware detection model to the similarity vectors.

4. The method of claim 1, wherein the constructing step comprises:
producing a function call graph for each function of the binary executable.

5. The method of claim 4, wherein each function is represented by a feature vector corresponding to a histogram of all the instructions in the function.

6. The method of claim 1, wherein the determining step comprises:
constructing similarity scores between pairs of the call graphs using a machine learning algorithm.

7. The method of claim 1, wherein the parallelized graph kernels is a parallelized shortest path graph kernel (SPGK).

8. The method of claim 1, wherein the machine learning algorithm is a deep neural network (DNN).

9. The method of claim 7, wherein the determining step comprises:
executing a first portion of the parallelized SPGK on a central processing unit (CPU); and
executing a second portion of the parallelized SPGK on a graphics processing unit (GPU).

10. A malware detection system, the system comprising:
a heterogeneous system including a central processing unit (CPU) and a graphics processing unit (GPU), the heterogeneous system configured to:
obtain a plurality of malware binary executables and a plurality of goodware binary executables from a network;
decompile on the CPU the plurality of malware binary executables and the plurality of goodware binary executable to extract and store corresponding assembly code on a hard drive for each of the plurality of malware binary executables and the plurality of goodware executable;
construct on the CPU call graphs for each of the plurality of malware binary executables and the plurality of goodware binary executables from the corresponding assembly code;
store the constructed call graphs on the hard drive;
determine on the GPU similarities between the call graphs using parallelized graph kernels applied to the call graphs for each of the plurality of malware binary executables and the plurality of goodware binary executables;
build a malware detection model from the determined similarities between call graphs by applying a machine learning algorithm running on the CPU and the GPU to the determined similarities;
store the built malware detection model on the hard drive; and
identify whether a subject executable is malware by retrieving the built malware detection model from the hard drive and applying the built malware detection model to the subject executable.

11. The system of claim 10, wherein the heterogeneous system is configured to determine the similarities between call graphs and to build the malware detection model utilizing parallel processing.

12. The system of claim 10, wherein the heterogeneous system comprises a graphics processing unit (GPU) and a central processing unit (CPU).

13. The system claim 10, wherein the heterogeneous system may contain a multi-core processor.

14. The system of claim 10, wherein the heterogeneous system is further configured to:
associate one of a plurality of malware classes with each of the plurality of malware binary executables, wherein the processor builds the malware detection model by incorporating the associated classes in the built malware detection model using a deep neural network (DNN); and
classify the subject executable into one of the plurality of malware classes and determine capabilities of the subject executable using the built malware detection model.

15. The system of claim 10, wherein the heterogeneous system identifies malware by:
obtaining the subject executable;
decompiling the subject executable to extract subject assembly code;
constructing subject call graphs representing the subject assembly code;
creating similarity vectors representing similarity between the subject call graphs and the call graphs for each of the plurality of malware binary executables and the plurality of goodware binary executables using the parallelized graph kernels; and
identifying the subject executable as potential malware by applying the built malware detection model to the similarity vectors.

16. The system of claim 10, wherein the CPU constructs the call graphs by:
producing a function call graph for each function of each of the binary executable.

17. The system of claim 16, wherein each function is represented by a feature vector corresponding to a histogram of all the instructions in the function.

18. The system of claim 10, wherein the heterogeneous system determines similarities by:
constructing similarity scores between pairs of call graphs using a machine learning algorithm.

19. The system of claim 10, wherein the parallelized graph kernels is a parallelized shortest path graph kernel (SPGK).

20. The system of claim 19, wherein the heterogeneous system determined similarities by:
executing a first portion of the parallelized SPGK on a central processing unit (CPU); and
executing a second portion of the parallelized SPGK on a graphics processing unit (GPU).
